(19) United States
(12) Patent Application Publication
(10) Pub. No.: US 2010/0211699 A1
(43) Pub. Date: Aug. 19, 2010

(54) WIRELESS ACCESS APPARATUS WITH FIRMWARE UPGRADING FUNCTION AND THE METHOD THEREOF

(75) Inventors: KUEI FENG CHANG, Hsinchu County (TW); YING YUAN HUANG, Hsinchu County (TW)

Correspondence Address: WPAT, PC;INTELLECTUAL PROPERTY ATTORNEYS, 2030 MAIN STREET, SUITE 1300, IRVINE, CA, 92614, US

(73) Assignee: RALINK TECHNOLOGY CORPORATION, Hsinchu County (TW)

(21) Appl. No.: 12/557,326

(22) Filed: Sep. 10, 2009

(30) Foreign Application Priority Data
Feb. 13, 2009 (TW) 098104580

(51) Int. Cl. G06F 3/00; G06F 12/02

(52) U.S. Cl. 710/13; 711/103; 711/E12.008

(57) ABSTRACT

A wireless access apparatus comprises a memory, a connection interface, a microcontroller, and a network interface. The memory is configured for storing a firmware data, and the connection interface is configured for receiving firmware data to be upgraded. The microcontroller is configured for controlling a process of storing the firmware data to be upgraded in the memory, and the network interface is connected to the microcontroller.

### BACKGROUND OF THE INVENTION

1. Field of the Invention

The present invention relates to a firmware upgrading method and a system thereof, and more particularly to a wireless access apparatus and a system thereof with firmware upgrading function.

2. Description of the Related Art

Among a variety of computer apparatus, the operation of a number of hardware devices uses firmware data to manage the hardware resources such as optical disk drives or data modems. Firmware data includes a variety of information types, such as command, program, or instruction, so as to control the normal operation of the hardware. Firmware data also includes the data, parameters and instructions used to initialize the hardware device. Firmware data is usually stored in a memory, such as a nonvolatile random access memory or a flash memory. A system sometimes has a demand for upgrading the nonvolatile random access memory with a new firmware version. For example, if a system supplier issues a new firmware version to modify errors of an older version or to add a new function, then users have to download the new firmware version to upgrade the nonvolatile random access memory.

When a user proceeds to upgrade firmware data in a conventional way, he or she is required to obtain a network address, in which a system supplier stores firmware data to be upgraded, by a communication protocol through a modem, and then downloads the latest firmware data based on the network address. However, use of such download method can easily result in lost data envelopes due to the non-anticipation of the network status. Furthermore, if power failure occurs in the network apparatus or if a user carelessly disrupts a network line while upgrading firmware data, the data upgrade operation may fail and result in a serious consequence, such as an inability to turn on the system. In addition, users may be unfamiliar with the setup of the network environment, such as the step of keying in the parameter of correct network address and the netmask, and may therefore fail to download the upgrade firmware data from the network.

In addition, the application of embedded systems, such as personal digital assistant (PDA), cellular telephone, and network apparatus, is currently becoming increasingly popular. FIG. 1 shows a block diagram of a conventional embedded system 10. The conventional embedded system comprises a microcontroller 12, a network interface 14, a volatile random access memory (VRAM) 16, and a nonvolatile random access memory (NVRAM) 18 used to store firmware data 181. The embedded system 10 connects to an external network 19 via the internal network interface 14. When the firmware data 181 of the embedded system 10 needs to be upgraded, the microcontroller 12 downloads firmware data to be upgraded in the network 19 via the network interface 14. In order to prevent the NVRAM 18 from being loaded with incomplete data, the microcontroller 12 downloads the firmware data to be upgraded to the VRAM 16 first. When the complete firmware data arrives, the completed data is then put to the NVRAM 18. The embedded system is usually designed for a certain application, and thus it only has a small amount of memory space. However, the embedded system requires additional memory space when the firmware data is upgraded. Therefore the microcontroller 12 can easily cause system instability and a subsequent data upgrade failure during the arrangement of the memory space.

Therefore, it is desirable to provide a firmware upgrading method and system thereof for solving the problems mentioned above.

### SUMMARY OF THE INVENTION

An aspect of the present invention is to provide a wireless access apparatus with firmware upgrading function.

According to one embodiment of the present invention, the wireless access apparatus comprises a memory, a connection interface, a microcontroller, and a network interface. The memory is configured for storing a firmware data, and the connection interface is configured for receiving firmware data to be upgraded. The microcontroller is configured for controlling a process of storing the firmware data to be upgraded in the memory, and the network interface is connected to the microcontroller.

Another aspect of the present invention is to provide a firmware upgrading method of a wireless access apparatus.

According to one embodiment of the present invention, the firmware upgrading method of the wireless access apparatus comprises connecting a portable storage apparatus to the wireless access apparatus; executing an upgrading step if all firmware data to be upgraded in the portable storage apparatus is enumerated via a connection interface by the wireless access apparatus; and selecting an access path of the firmware data to be upgraded and storing the firmware data in the portable storage apparatus via a network interface and the connection interface if not all firmware data to be upgraded in the portable storage apparatus is enumerated via a connection interface by the wireless access apparatus.

### BRIEF DESCRIPTION OF THE DRAWINGS

The invention will be described according to the appended drawings in which:

FIG. 1 shows a block diagram of a conventional embedded system;

FIG. 2 shows one embodiment of the wireless access apparatus;

FIG. 3 shows the flow chart of one embodiment of the method of the present invention;

FIG. 4 shows the flow chart of one embodiment of the display and upgrading step of the present invention; and

FIG. 5 shows the flow chart of another embodiment of the firmware upgrade method of the present invention.

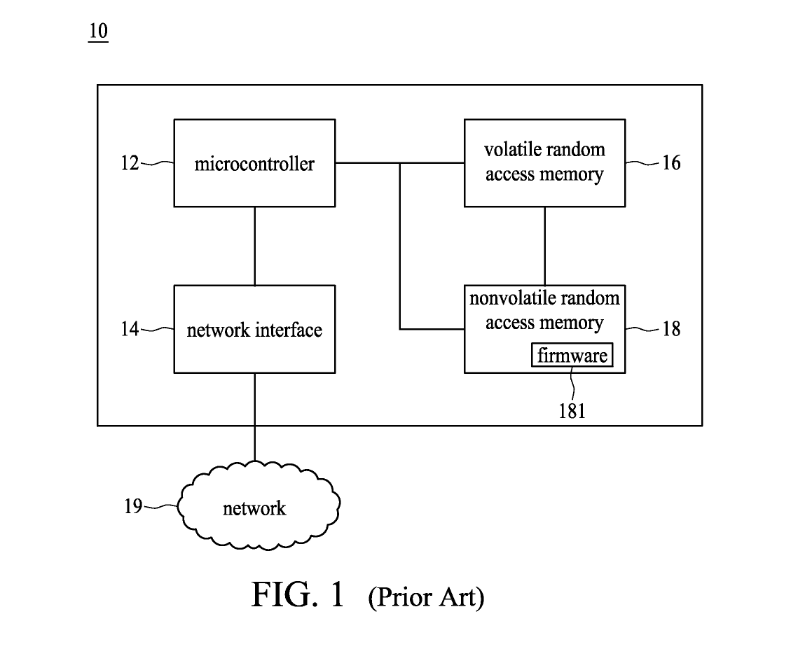

### DETAILED DESCRIPTION OF THE INVENTION

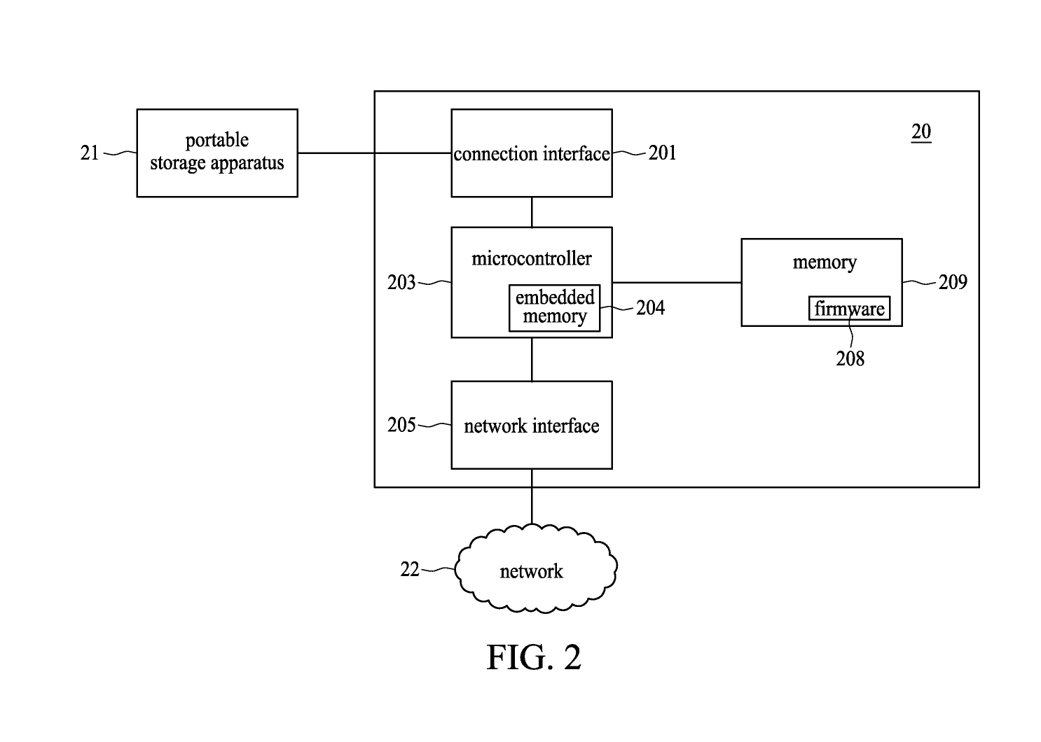

In order to explain the firmware upgrading method of the present invention more clearly, a wireless access apparatus will be described that performs the method of the present invention. FIG. 2 shows one embodiment of the wireless access apparatus 20. The wireless access apparatus 20 comprises a connection interface 201, such as a universal serial bus interface (USB interface) or a serial advanced technology attachment (SATA interface). The wireless access apparatus 20 also comprises a microcontroller 203, a network interface 205, and a memory 209, such as an NVRAM, used to store a firmware data 208. The microcontroller 203 has a small amount of embedded memory 204. The wireless access apparatus 20 connects to an external network 22 via the network interface 205, and the connection interface 201 connects to an external portable storage apparatus 21. In accordance with one embodiment of the present invention, the wireless access apparatus 20 can be either an access point (AP) or a wireless router. In this case, the microcontroller 203 is used to execute a media access control (MAC), and the connection interface 201 connects to an external printer so that users can share the printer via a local area network or an internal network.

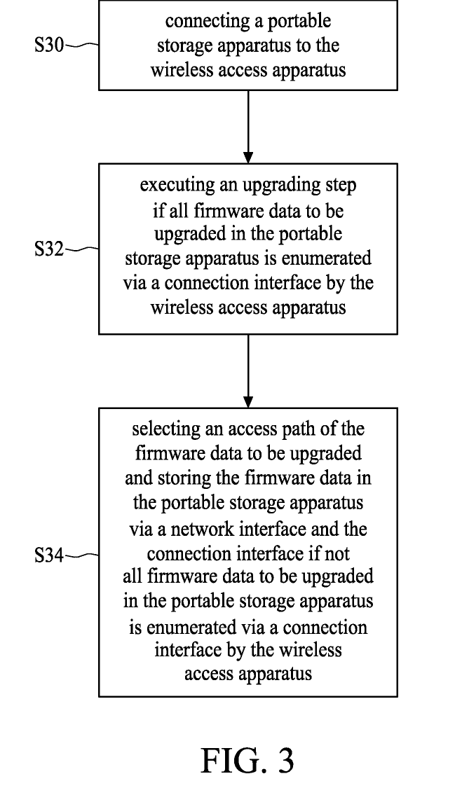

FIG. 3 shows the flow chart of one embodiment of the method of the present invention. In step S30, a user connects a portable storage apparatus to the wireless access apparatus. In step S32, an upgrading step is executed if all firmware data to be upgraded in the portable storage apparatus is enumerated via a connection interface by the wireless access apparatus. In step S34, the user selects an access path of the firmware data to be upgraded and stores the firmware data in the portable storage apparatus via a network interface and the connection interface if not all firmware data to be upgraded in the portable storage apparatus is enumerated via a connection interface by the wireless access apparatus. The following shown on FIG. 2 and FIG. 3 describes the details of the firmware upgrading method of the present invention.

First, when a user needs to upgrade firmware data, he or she can use the external portable storage apparatus 21, such as a thumb drive, to download the firmware data to be upgraded from a network via a connection interface of the portable storage apparatus 21. Connection interfaces such as USB interface or SATA interface are becoming a current market trend due to features such as a hot plug and plug-and-play operation. The hot plug operation allows users to add and remove the portable storage apparatus 21 from the wireless access apparatus 20 without powering on the wireless access apparatus 20 again. With the plug-and-play operation, the users can plug the portable storage apparatus 21 to the wireless access apparatus 20 and use the wireless access apparatus 20 immediately without concern of device conflicts. According to another embodiment of the present invention, the user can obtain the firmware data to be upgraded with the portable storage apparatus 21 from a system supplier directly.

Next, the user connects the portable storage apparatus 21 to the wireless access apparatus 20, i.e., an access point, and then prepares to read the firmware data to be upgraded from the connection interface 201 of the wireless access apparatus 20. Meanwhile, the wireless access apparatus 20 checks whether all firmware data to be upgraded in the portable storage apparatus 21 is enumerated via the connection interface 201. If yes, a display and upgrading step is executed.

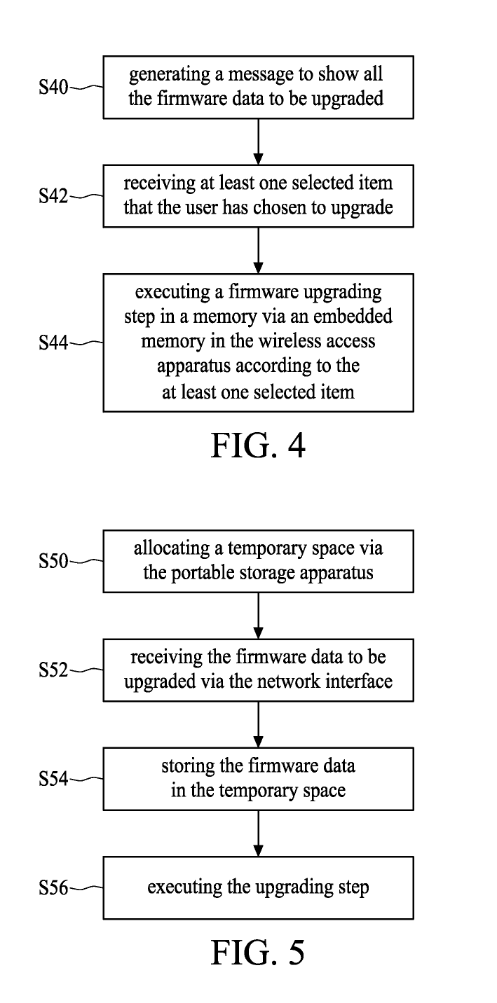

FIG. 4 shows the flow chart of one embodiment of the display and upgrading step of the present invention. In step S40, a message is generated to show all the firmware data to be upgraded. In step S42, at least one item that the user has selected for upgrade is received. In step S44, a firmware upgrading step is executed in a memory via an embedded memory in the wireless access apparatus according to the at least one selected item.

When executing the display and upgrading step, the user can select the firmware data to be upgraded via a graphical user interface on a screen of a personal computer (not shown) connected to the wireless access apparatus 20. The graphical user interface enumerates all the firmware data to be upgraded in the portable storage apparatus 21 and the user selects some specific items including the desired upgrade version.

After the user indicates the selected items, the microcontroller 203 writes the selected firmware data to be upgraded to the memory 209 via the embedded memory 204 for preparing to upgrade the firmware data 208. The memory 209 can be a flash memory. If the memory 209 is a flash memory, the method of upgrading the firmware data comprises the following steps. First, the storage of the flash memory or the partial area of the flash memory is cleared. Next, the firmware data to be upgraded is written to the cleared flash memory. According to another embodiment of the present invention, the upgrade steps are different when using other types of memory.

If the wireless access apparatus 20 cannot enumerate all the firmware data to be upgraded in the portable storage apparatus 21, the user is required to select another access path of the firmware data to be upgraded. FIG. 5 shows the flow chart of another embodiment of the firmware upgrade method of the present invention. In step S50, the portable storage apparatus allocates a temporary space. In step S52, the firmware data to be upgraded is received via the network interface. In step S54, the firmware data is stored in the temporary space. In step S56, the upgrading step is executed. The following description gives further details of the present invention, as shown in FIGS. 2 and 5.

First, the user selects another access path of the firmware data to be upgraded to upgrade the firmware. The access path can be an outside web address, or a designated path in the personal computer. After selecting the path, the wireless access apparatus 20 receives the firmware data to be upgraded via the network interface 205. The portable storage apparatus 21 allocates a temporary space to store the firmware data in the temporary space. Next, the microcontroller 203 writes the firmware data to be upgraded to the memory 209 via the embedded memory 204 for preparing to upgrade the firmware data 208.

A user downloads firmware data to be upgraded via a network interface in a conventional wireless access apparatus. The above-mentioned upgrade method is determined mainly according to the network status. In order to prevent an NVRAM from being loaded with an incomplete writing operation, the wireless access apparatus using such upgraded method requires a large amount of a VRAM for storing the firmware data to be upgraded temporarily. However, the firmware upgrading method of the present invention only requires a small amount of memory 204 to complete the firmware upgrading operation in the case of using the connection interface 201 to receive the firmware data to be upgraded from the portable storage apparatus 21 or in the case of using the network interface 205 to receive the firmware data to be upgraded. This is because the method of the present invention uses a connection interface 201 having a fixed and high speed of data transmission rate to download the firmware data to be upgraded.

The above-described embodiments of the present invention are intended to be illustrative only. Numerous alternative embodiments may be devised by those skilled in the art without departing from the scope of the following claims.

What is claimed is:

1. A wireless access apparatus, comprising:
a memory configured for storing firmware data;
a connection interface configured for receiving firmware data to be upgraded;
a microcontroller configured for controlling a process of storing the firmware data to be upgraded in the memory; and
a network interface connected to the microcontroller.

2. The wireless access apparatus of claim 1, wherein the connection interface receives the firmware data to be upgraded from an external portable storage apparatus.

3. The wireless access apparatus of claim 2, wherein the portable storage apparatus is a thumb drive.

4. The wireless access apparatus of claim 1, which is an access point or a router.

5. The wireless access apparatus of claim 1, wherein the memory is a flash memory or a nonvolatile random access memory.

6. The wireless access apparatus of claim 1, wherein the firmware data to be upgraded is written to the memory via an embedded memory of the microcontroller.

7. The wireless access apparatus of claim 1, wherein the connection interface is a universal serial bus (USB) interface or a serial advanced technology attachment (SATA) interface.

8. The wireless access apparatus of claim 2, wherein when the firmware data to be upgraded is received via the network interface, the portable storage apparatus allocates a temporary space for storing the firmware data to be upgraded in the temporary space via the connection interface.

9. The wireless access apparatus of claim 8, wherein the firmware data to be upgraded is written to the memory via the embedded memory of the microcontroller.

10. A firmware upgrading method for a wireless access apparatus, comprising the steps of:
connecting a portable storage apparatus to the wireless access apparatus;
executing an upgrading step if all firmware data to be upgraded in the portable storage apparatus is enumerated via a connection interface by the wireless access apparatus; and
selecting an access path of the firmware data to be upgraded and storing the firmware data in the portable storage apparatus via a network interface and the connection interface if not all firmware data to be upgraded in the portable storage apparatus is enumerated via a connection interface by the wireless access apparatus.

11. The firmware upgrading method of claim 10, wherein the step of storing the firmware data comprises:
allocating a temporary space via the portable storage apparatus;
receiving the firmware data to be upgraded via the network interface;
storing the firmware data in the temporary space; and
executing the upgrading step.

12. The firmware upgrading method of claim 11, wherein the upgrading step comprises:
generating a message to show all the firmware data to be upgraded;
receiving at least one selected item that the user has chosen to upgrade; and
executing a firmware upgrading step in a memory via an embedded memory in the wireless access apparatus according to the at least one selected item.

13. The firmware upgrading method of claim 10, wherein the portable storage apparatus is a thumb drive.

14. The firmware upgrading method of claim 12, wherein the memory is a flash memory.

15. The firmware upgrading method of claim 14, wherein the firmware upgrading step comprises:
clearing the content of the flash memory; and
writing the firmware data to be upgraded to the flash memory.

16. The firmware upgrading method of claim 12, wherein the memory is a nonvolatile random access memory.

17. The firmware upgrading method of claim 12, wherein the at least one selected item comprises a desired upgraded version.

18. The firmware upgrading method of claim 12, wherein the message is displayed on a graphical user interface.

19. The firmware upgrading method of claim 10, wherein the connection interface is a USB interface or a SATA interface.
